(19) United States
(12) Patent Application Publication
(10) Pub. No.: US 2007/0118273 A1
(43) Pub. Date: May 24, 2007

(54) Method and system for obtaining traffic information using transponders

(76) Inventors: Wai-Cheung Tang, Mannheim (CA); Thua Van Ho, Mississauga (CA)

Correspondence Address: HANLEY, FLIGHT & ZIMMERMAN, LLC, 150 S. WACKER DRIVE, SUITE 2100, CHICAGO, IL, 60606, US

(21) Appl. No.: 11/284,277

(22) Filed: Nov. 21, 2005

(51) Int. Cl. G08G 1/00

(52) U.S. Cl. 701/117

(57) ABSTRACT

A method and system for obtaining traffic information regarding the travel time between two points using vehicle-mounted transponders. The system includes an upstream reader and a downstream reader. The upstream reader inserts a time stamp into a passing transponder. The downstream reader reads the time stamp and determines the travel time between the two readers. The downstream reader may accumulate a number of travel times from multiple transponders and calculate an average travel time. The downstream reader may then send the calculated travel time to a display sign for display to motorists. The displayed travel time may include a quantitative value or a qualitative assessment of the travel conditions.

### FIELD OF THE INVENTION

The present invention relates to traffic management and, in particular, to a method and system for obtaining traffic information using transponders.

### BACKGROUND OF THE INVENTION

Electronic toll collection systems conduct toll transactions electronically using RF communications between a vehicle-mounted transponder (a “tag”) and a stationary toll plaza transceiver (a “reader”). An example of an electronic toll collection system is described in U.S. Pat. No. 6,661,352 issued Dec. 9, 2003 to Tiernay et al., and owned in common with the present application. The contents of U.S. Pat. No. 6,661,352 are hereby incorporated by reference.

In a typical electronic toll collection (ETC) system, the reader broadcasts a wakeup or trigger RF signal. A tag on a vehicle passing through the broadcast area or zone detects the wakeup or trigger signal and responds with its own RF signal. The tag responds by sending a response signal containing information stored in memory in the transponder, such as the transponder ID number. The reader receives the response signal and may conduct an electronic toll transaction, such as by debiting a user account associated with the transponder ID number. The reader may then broadcast a programming RF signal to the tag. The programming signal provides the tag with updated information for storage in its memory. It may, for example, provide the tag with a new account balance.

Traffic management and transportation authorities currently attempt to alert vehicle occupants to upcoming traffic conditions using overhead or roadside display signs. For example, a display sign may indicate the traffic conditions in the road ahead. By way of example, a display sign may indicate the travel time between the current location and a location some distance down the road, such as the next exit, the next toll plaza, the next town, etc. Vehicle occupants may then use this information about travel conditions to determine whether or not to travel on the roadway.

Unfortunately, the information given is sometimes inaccurate. The displayed information may come from human estimations based on observed travel conditions, although this is labour intensive. In some cases, measurements are made of traffic conditions to determine the approximate travel time.

Some traffic information systems attempt to capitalize on the presence of ETC transponders in the roadway in order to measure the traffic conditions. For example, a system may (a) read a vehicle transponder at an upstream reader and send time and transponder ID information to a back office location, (b) read the vehicle transponder at a downstream reader and send time and transponder ID information to the back office location. The back office location then attempts to match transponder IDs and determine the travel time based upon the time stamps from the upstream and downstream locations. After processing information from a sufficient number of transponders, an average travel time is calculated and displayed on a display sign by the roadway.

A problem associated with existing systems that rely on ETC transponders is a privacy concern with the communication of transponder IDs. The traffic information system is often implemented and/or managed by a different entity than the ETC system. In the existing systems, the transponder IDs are sent wirelessly over a unsecured cellular network or other wireless network from the readers to the back office location.

Another problem associated with the existing systems is the high cost and overhead associated with communicating from both readers to a back office for every transponder. These communications are often made using the cellular telephone network, which can be expensive.

It would be advantageous to have an improved method and system for obtaining traffic information using transponders.

### SUMMARY OF THE INVENTION

The present invention provides a method and system for obtaining traffic information regarding the travel time between two points using vehicle-mounted transponders. The system includes an upstream reader and a downstream reader. The upstream reader inserts a time stamp into the memory of a passing transponder. The downstream reader reads the time stamp and determines the travel time between the two readers. The downstream reader may accumulate a number of travel times and calculate an average travel time. The downstream reader may then send the calculated travel time to a display sign for display to motorists, or may send information based upon the calculated travel time. The displayed travel time may include a quantitative value or a qualitative assessment of the travel conditions.

In one aspect, the present invention provides a method of obtaining traffic information regarding a roadway using a vehicle equipped with a transponder having a memory. The roadway includes a downstream reader having a downstream communications zone over a first portion of the roadway and an upstream reader having an upstream communication zone over a second portion of the roadway. The upstream communication zone is separated from the downstream communication zone by a distance of the roadway. The roadway includes a display sign. The method includes the steps of sending a time stamp to the transponder for storage in the memory of the transponder while the vehicle traverses the upstream communication zone and reading the time stamp from the memory of the transponder when the vehicle is in the downstream communication zone. It further includes steps of determining a travel time from the upstream communication zone to the downstream communication zone based upon the time stamp, and determining travel time information based upon the travel time.

In another aspect, the present invention provides a system for obtaining traffic information regarding a roadway upon which vehicles equipped with transponders travel. The transponders each have a memory. The system includes a downstream reader having a downstream communications zone over a first portion of the roadway and an upstream reader having an upstream communication zone over a second portion of the roadway. The upstream communication zone is separated from the downstream communication zone by a distance of the roadway. The upstream reader has a time stamp transceiver for sending a time stamp to the transponder for storage in the memory of the transponder while one of the vehicles traverses the upstream communication zone. The downstream reader includes an interrogation transceiver for reading the time stamp from the memory of the transponder when the vehicle is in the downstream communication zone. It also includes a travel time module for determining a travel time from the upstream communication zone to the downstream communication zone based upon the time stamp and determining travel time information based upon the travel time.

In yet another aspect, the present invention provides a downstream reader for use in a system for obtaining traffic information regarding a roadway upon which vehicles equipped with transponders travel. The transponders each have a memory. The system includes an upstream reader having an upstream communication zone. The upstream reader stores a time stamp in the memory of a transponder while a vehicle traverses the upstream communication zone. The downstream reader includes a downstream antenna having a downstream communication zone over a portion of the roadway and an interrogation transceiver connected to the downstream antenna for sending an interrogation signal to the transponder and receiving a response signal. The response signal includes the time stamp. The downstream reader includes a travel time module for determining a travel time from the upstream communication zone to the downstream communication zone based upon the time stamp and determining travel time information based upon the travel time.

Other aspects and features of the present invention will be apparent to those of ordinary skill in the art from a review of the following detailed description when considered in conjunction with the drawings.

### BRIEF DESCRIPTION OF THE DRAWINGS

Reference will now be made, by way of example, to the accompanying drawings which show an embodiment of the present invention, and in which:

FIG. 1 shows, in block diagram form, an embodiment of a traffic information system associated with an extent of roadway for vehicular traffic;

FIG. 2 shows a table detailing a transponder information data structure according to a pre-defined ETC protocol;

FIG. 3 shows a block diagram of an alternative embodiment of the traffic information system;

FIG. 4 shows a block diagram of an embodiment of an upstream reader for the traffic information system;

FIG. 5 shows a block diagram of an embodiment of a downstream reader for the traffic information system; and

FIG. 6 shows, in flowchart form, an embodiment of a method of obtaining traffic information.

Similar reference numerals are used in different figures to denote similar components.

### DESCRIPTION OF SPECIFIC EMBODIMENTS

The present application describes a system and method for obtaining traffic information that relies upon existing transponders to carry time stamp information from an upstream reader to a downstream reader. The upstream reader may provide the transponder with a time stamp and a location ID, which the transponder stores in its memory. The downstream reader extracts this information from the transponder memory and uses it to determine a travel time between the two locations. By averaging the travel times of a number of transponders, the downstream reader can determine an average travel time between the two points, which may then be displayed for motorists on a display sign near or over the roadway.

Some of the embodiments described below suggest the use of electronic toll collection (ETC) transponders. The systems and methods described below may be incorporated into an ETC system; however, they may be implemented separately even when using ETC-enabled transponders. In other words, the readers used for obtaining traffic information may or may not be involved in conducting ETC transactions. In some embodiments, non-ETC transponders may be used. The transponders may be related to commercial vehicle operations (CVO) systems, for example, or may have other primary uses. In some embodiments, the transponders may be related to manufacturer-installed on-board-diagnostics systems. In another example, the transponders may be dedicated to the traffic management systems and methods described herein.

It will also be appreciated that the described methods and systems may be implemented on toll roads or on non-toll roads. A non-toll road may carry a sufficient number of vehicles equipped with transponders to support the system and methods described below. It will be understood that the described system obtains an average or approximate travel time between two points in a roadway and, as such, it does not need to determine the travel time of every vehicle in the roadway; only a representative sample of the traffic is needed. Accordingly, not all vehicles programmed at the upstream reader need to be read at the downstream reader.

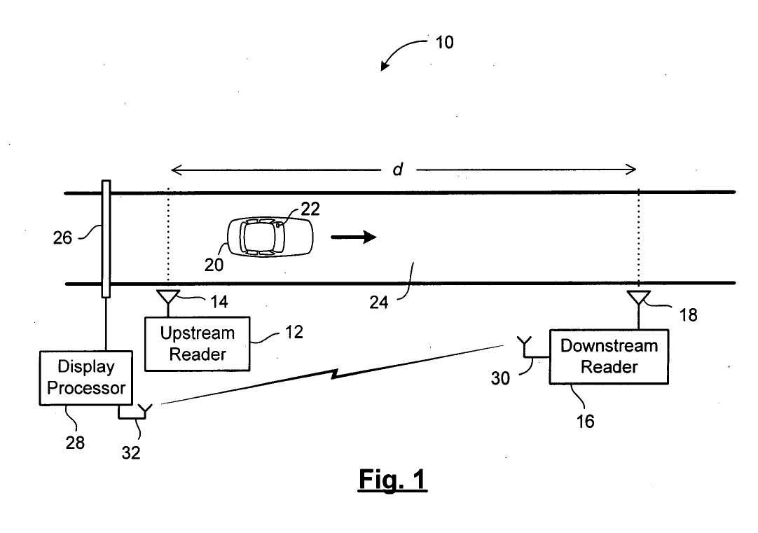

Reference is first made to FIG. 1, which shows, in block diagram form, an embodiment of a traffic information system 10 associated with an extent of roadway 24 for vehicular traffic. For simplicity, the roadway 24 is illustrated as having a single lane for traffic, although it will be appreciated that the roadway 24 may have, and usually does have, multiple lanes. A vehicle is indicated by reference numeral 20, and the direction of travel is indicated by an arrow. The vehicle 20 is equipped with a transponder 22. The transponder 22 may be active or passive, provided that the transponder 22 includes a memory having a least a portion for storing data in accordance with instructions from a remote reader.

The traffic information system 10 includes a display sign 26, an upstream reader 12, and a downstream reader 16, wherein “upstream” and “downstream” refer to the direction of vehicular travel in the roadway 24. The upstream reader 12 is located in the general vicinity of the display sign 26. In the embodiment illustrated in FIG. 1, the upstream reader 12 is located downstream from the display sign 26, although in other embodiments it may be upstream or at the same location. The downstream reader 16 is located a distance d down the roadway 24 from the upstream reader 12. The distance d may be any distance over which traffic information is to be gathered, but is typically in the range of 1 to 10 kilometers.

The display sign 26 is positioned over or next to the roadway 24 such that drivers of vehicles 20 coming towards the display sign 26 may read the information shown on the display sign 26. The display sign 26 may be an electronic message board that is controlled by a display processor 28 to display a selected message. The message may be varied by the display processor 28 from time-to-time. By way of example only, the displayed message may be used to warn of congestion in the roadway 24, advise of upcoming construction or lane-closures, suggest good driving habits, and/or display time or temperature information, among other things. In particular, the display sign 26 may indicate the travel time from the location of the display sign 26 to a location further down the roadway 24. For example, it may indicate the travel time to reach the next exit, next toll plaza, next highway interchange, next municipality, etc.

The upstream reader 12 includes an upstream antenna 14 having a coverage zone that includes at least a portion of the roadway 24. The upstream reader 12 and antenna 14 may communicate with transponders 22 that enter the coverage zone. In particular, the upstream reader 12 may excite the upstream antenna 14 so as to propagate a trigger or wake-up signal within the coverage zone. If a transponder 22 is located within the coverage zone, it responds by sending a response signal, which is received by the upstream antenna 14 and processed by the upstream reader 12. The upstream reader 12 then provides the transponder 22 with a time stamp. The upstream reader 12 may also provide the transponder 22 with a location ID. The time stamp and location ID may be contained in a programming signal broadcast by the upstream antenna 14 to the transponder 22. The time stamp and location ID are stored in memory by the transponder 22.

The downstream reader 16 includes a downstream antenna 18. The downstream antenna 18 has a coverage area over at least a portion of the roadway 24, such that it is capable of communicating with transponders 22 that pass through the coverage area. The downstream reader 16 causes the downstream antenna 18 to broadcast an interrogation signal and process any response signals. A transponder 22 in the coverage area responds to the interrogation signal by sending a response signal containing transponder information, such as the time stamp and location ID stored in the transponder memory.

On obtaining the location ID and time stamp, the downstream reader 16 compares the present time with the time stamp to obtain a travel time between the two readers 12 and 16 over the distance d. Travel times may be accumulated by the downstream reader 16 and may be used to determine an average travel time for the distance d of the roadway 24. It will be appreciated that the downstream reader 16 includes a timer or clock that provides a source for the present time.

The downstream reader 16 includes a communication antenna 30. The communication antenna 30 enables RF communication with the display processor 28, which includes a corresponding communication antenna 32. The RF communication between the downstream reader 16 and the display processor 28 may be a direct wireless transmission, such as a microwave signal. In another embodiment, as described further below, a wireless network like a cellular network, may be used for communications between the downstream reader 16 and the display processor 28.

The downstream reader 16 may send average travel time information to the display processor 28 for display on the display sign 26. In one embodiment, the downstream reader 16 sends the average travel time information periodically. In another embodiment, the downstream reader 16 sends average travel time information only when an updated average travel time differs from the current average travel time by more than a threshold amount, such as, for example, 5% or 10%. In one embodiment, the downstream reader 16 may be configured to send updated information, if required, in fifteen minute intervals. Other variations in reporting procedure and/or frequency will be understood by those of ordinary skill in the art.

It will be appreciated that the display sign 26 may display information other than the average travel time in connection with the traffic information gathered by the system 10. For example, knowing the distance d the system 10 may determine an average traffic speed for the roadway 24, which may then be displayed on the display sign 26. In another example, the average travel time may be used to provide a qualitative assessment of the traffic, such a “slow”, “very slow”, “normal”, etc., for display on the display sign 26. Other possibilities will be appreciated by those of ordinary skill in the art.

The protocol for communication between transponders 22 and the readers 12 and 16 is a two-way radio frequency (RF) communications protocol. In one embodiment, the RF carrier signals used are about 915 MHz and have a data bit rate of about 500 kbps.

In another embodiment, the display sign 26 may be located at or near the downstream reader 16, in which case the downstream reader 16 may not include a communication antenna 30 for sending average travel time information to the display processor 28. The display processor 28 may, in one embodiment, be incorporated within the downstream reader 16. In such embodiments, the distance between the upstream reader 12 and the downstream reader 16 may be relatively small, such as, for example, about 50 meters.

In yet another embodiment, the downstream reader 16 may send travel time information other than the average travel time to the display sign 26. For example, a qualitative description of the traffic conditions or a code corresponding to such a qualitative description may be determined at the downstream reader 16, and this description or code may be transmitted to the display sign 26 via RF communications. Other variations will be appreciated by those skilled in the art.

In yet a further embodiment, the downstream reader 16 may send the travel time information to a remote location other than the display sign 26. For example, the downstream reader 16 may send the travel time information to a central office or computer for processing and/or storage. The central office or computer may accumulate the travel time information from various locations to perform traffic analysis, planning, management, etc. In some embodiments, the central office or computer may send travel time information to the display sign 26 for display.

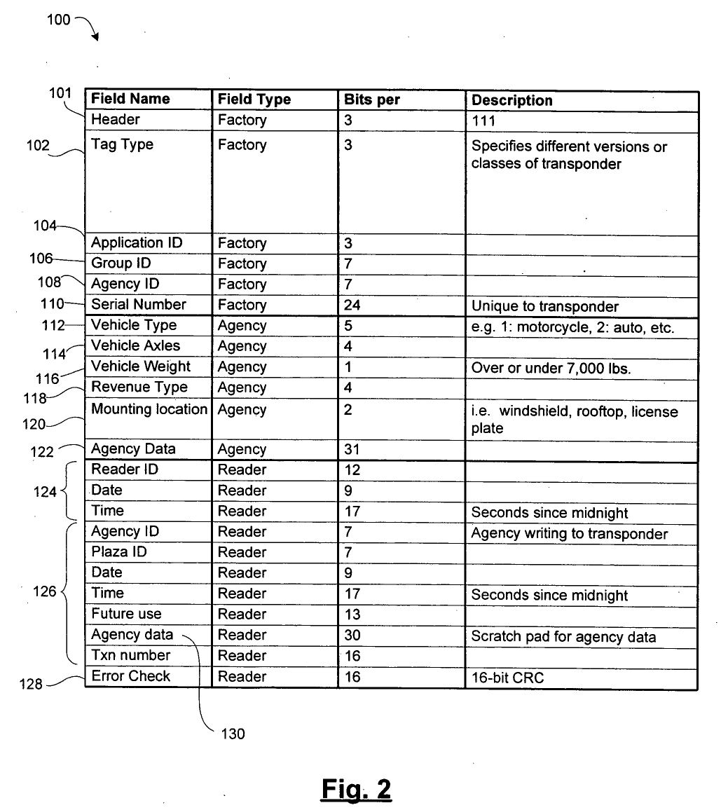

Reference is now made to FIG. 2, which shows a table 100 detailing a transponder information data structure according to a pre-defined ETC protocol. The pre-defined ETC protocol specifies a data structure (also referred to as a data string) containing a plurality of fields. The data structure or string may be stored in memory within the transponder.

The data string contains three types of fields, as indicated under the table heading “Field Type”: Factory fields, Agency fields, and Reader fields. The field type identifies the entity that is permitted to alter the contents of the particular field. The Factory fields are set by the manufacturer of the transponder and tend to relate to the characteristics of the transponder, i.e. the data in the Factory fields is read-only data. The Agency fields are fields that may be set by the agency deploying the transponders, and thus relate to the vehicle or customer characteristics. The Reader fields are fields that may be altered by individual readers. In one embodiment, these are fields that are used to track the movement of the transponder within an electronic toll collection system. For example, the Reader fields include fields for recording entry and exit points and the time and dates of entry or exit. In other embodiments, the Reader fields may include account information which a reader verifies and then debits in an automatic parking system, automated drive-through retail outlet, or other mobile commerce system.

The table 100 shown in FIG. 2 contains a number of Factory fields, including a Header field 101, a Tag Type field 102, an Application ID 104, a Group ID 106, an Agency ID 108, and a serial number field 110. Because the Factory fields are set by the manufacturer, the content of the fields is well defined and predictable. For example, within the Tag Type field 102 and the Application ID field 104, there may be certain bit combinations that have not been used for known tags or applications. These bit combinations may be reserved for future use, as the categories of tags and applications develop and expand. The Tag Type field 102 may be used by the reader to distinguish between two or more different classes of transponders.

The Agency fields include a Vehicle Type field 112, a Vehicle Axles field 114, a Vehicle Weight field 116, a Revenue Type field 118, a Mounting location field 120, and an Agency Data field 122.

The Reader fields may include a set of timing fields 124 and a set of toll collection fields 126 that may be altered by a roadside reader. Within the toll collection fields 126, there may be an agency data field 130 provided as a ‘scratch pad’. The last field in the data string illustrated by the table 100 is a Reader-class Error Check field 128 containing a 16-bit cyclic redundancy code (CRC). The Error Check field 128 is used by the reader to verify that data from the transponder has been received correctly.

From the table 100 in FIG. 2, it will be observed that the pre-defined protocol defines a data string containing 247 bits, including 47 bits in Factory fields, 47 bits for Agency fields, and 153 bits for Reader fields.

In an ETC operation, when a reader interrogates (i.e. triggers) a transponder, the transponder responds by transmitting a response signal containing the data string stored in local memory. In other words, the transponder sends the contents of its local memory to the reader. The reader then makes any modifications necessary to the Reader fields and transmits the modified data string back to the transponder. In one embodiment, the reader may not transmit the whole string, since many fields cannot be altered. The transponder receives a program signal containing the data string (or a portion of the data string) that includes the modified information. The transponder then stores the Reader fields from the program signal in place of the previous Reader fields in its local memory. The reader may then transmit a further trigger signal to re-read the transponder memory to verify that the transponder information has been updated in accordance with the modifications made by the reader.

In one embodiment of the present invention, wherein the traffic information system 10 is a part of an ETC system, the traffic information system 10 relies upon the timing fields 124 and/or toll collection fields 126 for time stamp information and location IDs in connection with the upstream reader.

In some embodiments, the time stamp and location ID from the upstream reader may be stored in the agency data field 130, i.e. the scratch pad. This may especially be the case where the traffic information system 10 is not a part of the ETC system and/or is implemented on a non-toll roadway. In such embodiments, the traffic information system 10 may have sufficient permission to write data to the scratch pad, but may not have sufficient authorization to alter the other fields in the transponder data structure.

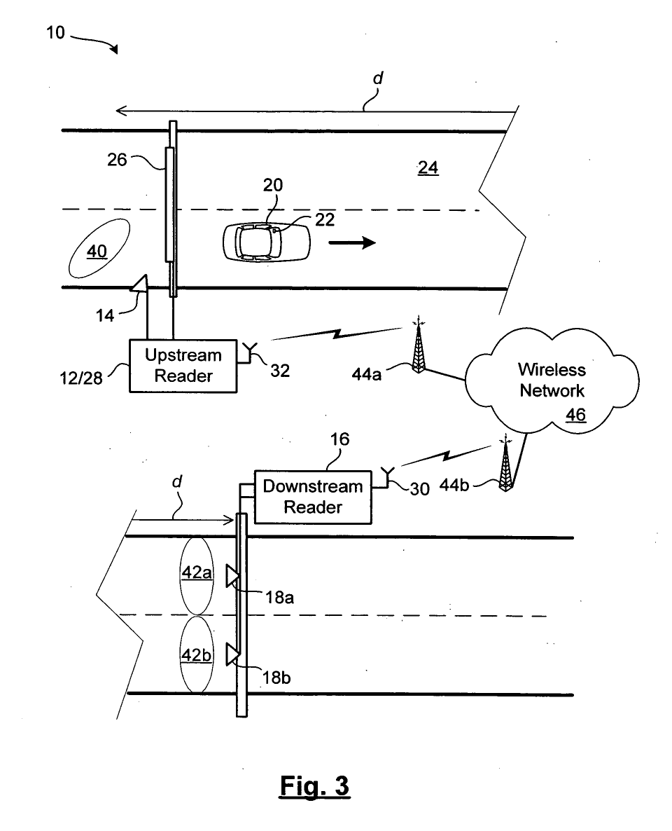

Reference is now made to FIG. 3, which shows a block diagram of an alternative embodiment of the traffic information system 10. In the embodiment shown in FIG. 3, the display processor 28 (FIG. 1) and upstream reader 12 are integrated at a common location. The upstream antenna 14 is a directional antenna having a coverage zone 40 having an approximately elliptical shape and covering a portion of the roadway 24. The downstream reader 16 features two downstream antennas 18a and 18b having adjacent coverage areas 42a and 42b spanning the roadway 24. It will be understood that although the coverage zones 40, 42a, and 42b are illustrated as having elliptical shapes, in reality the actual shapes of the coverage zones 40, 42a, and 42b will typically not be elliptical, but will have a shape that is dependent upon a number of factors, including RF reflections or interference caused by nearby structures, the antenna pattern and mounting orientation. The upstream reader 12 may include more than one antenna in other embodiments. The downstream reader 16 may include fewer than two or more than two antennas in other embodiments.

The downstream communication antenna 30 and upstream communication antenna 32 communicate via a wireless network 46. The wireless network 46 includes an upstream access point 44a and a downstream access point 44b. In one embodiment, the upstream and downstream access points 44a, 44b may be the same, although in many cases they will be different. The wireless network 46 may include a wireless communications network or combination of interconnected networks, including, without limitation, Mobiltex™, DataTAC™, AMPS, TDMA, CDMA, GSM/GPRS, PCS, EDGE, UMTS or CDPD. The wireless network 46 may further include the public switch telephone network (PSTN). Communications with the wireless network by the upstream and downstream readers 12, 16 use wireless protocols familiar to those of ordinary skill in the art. In one embodiment, the communications between the readers 12, 16 through the wireless network 46 are made by way of short message service (SMS).

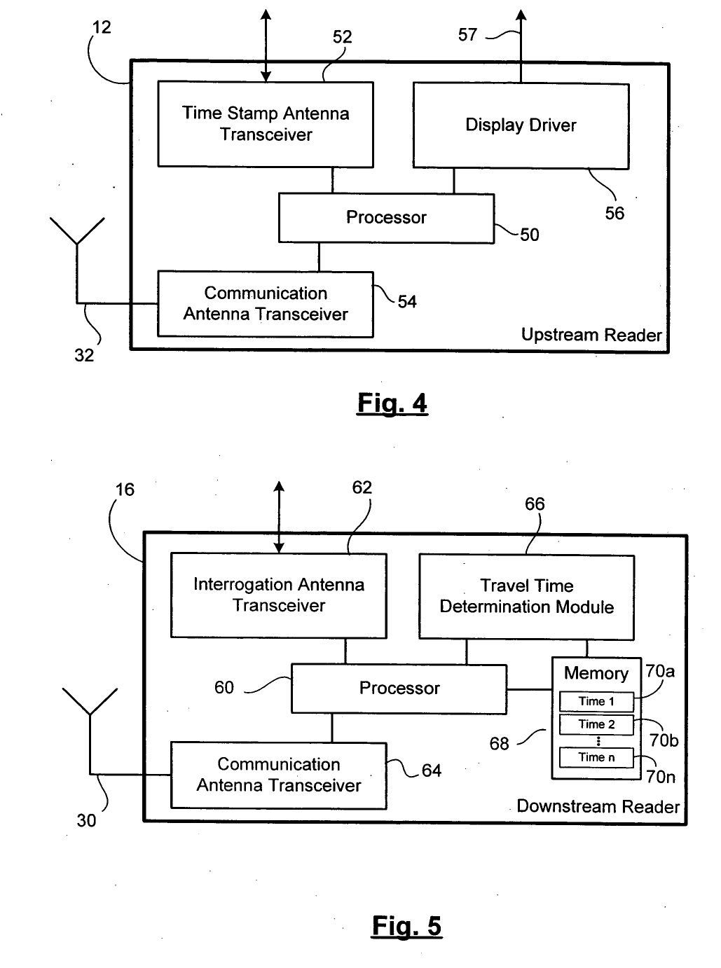

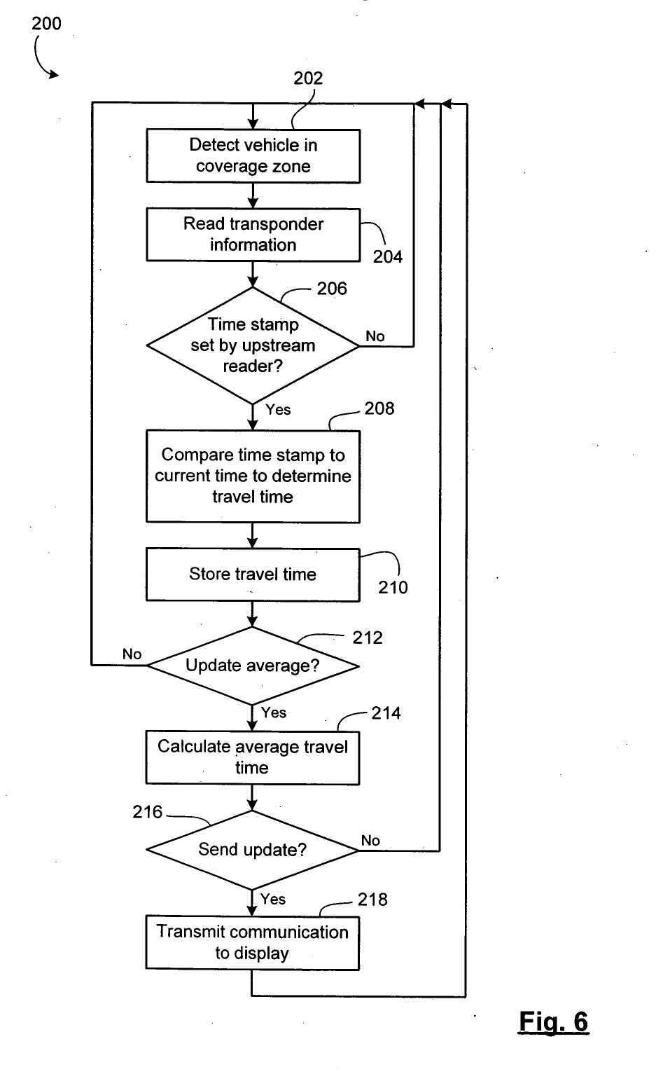

Reference is now made to FIGS. 4 and 5, which show block diagrams of embodiments of the upstream reader 12 and the downstream reader 16, respectively. It will be appreciated that the upstream reader 12 shown in FIG. 4 integrates the functions of operating the display sign 26 (FIG. 1). In some embodiments, these functions may be embodied in a separate device/system.

The upstream reader 12 includes a processor 50 operating under program control. The processor 50 may be implemented as a general purpose processor configured to perform the operations and functions described herein by way of stored program control. Suitable programming of a general purpose microprocessor or microcontroller will be within the skill of a person of ordinary skill in the art. Program instructions may be stored in firmware and/or temporary memory. In other embodiments, the processor 50 may be implemented through a configurable logic device, such as a field programmable gate array. In other embodiments, the processor 50 may be implemented by way of an application-specific integrated circuit. In some embodiments, the processor 50 may include a combination of integrated and discrete components. The range of implementation possibilities will be understood by those skilled in the art.

The processor 50 interacts with a time stamp antenna transceiver 52. The time stamp antenna transceiver 52 generates the RF excitation signals for output to the upstream antenna 14 (FIG. 3) for interrogating transponders 22 (FIG. 3) in the upstream coverage zone 40 (FIG. 3). It also receives incoming RF signals from the upstream antenna 14, where the incoming RF signals are electric signals induced in the upstream antenna 14 by RF transmission from the transponders 22. The time stamp antenna transceiver 52 performs the protocols and functions for engaging in interrogation and response communications with the transponder 22 through the upstream antenna 14.

The time stamp antenna transceiver 52 also excites the upstream antenna 14 to send a programming signal to the transponder 22 instructing the transponder 22 to store a time stamp in memory. The time stamp may be obtained by the time stamp antenna transceiver 52 from the processor 50 or other timing source. Upon detecting the presence of a transponder 22 in the coverage zone 40, the time stamp antenna transceiver 52 sends the programming signal containing the time stamp to the transponder 22. In one embodiment, the programming signal further includes a location ID corresponding to the upstream reader 12.

The upstream reader 12 may further include the communication antenna transceiver 54 and the display driver 56. The display driver 56 outputs a display signal 57 to the display sign 26 (FIG. 1) to control what is displayed on the display sign 26. The display signal 57 may take one of many formats, depending on the nature of the display sign 26, as will be appreciated by those or ordinary skill in the art.

The content to be displayed on the display sign 26 may be obtained, at least in part, by the display driver 56 from the processor 50, the communication antenna transceiver 54 and/or a memory (not shown). The obtained content may include content received through the communication antenna transceiver 54 from the downstream reader 16, such as the average travel time between the upstream reader 12 and downstream reader 16.

The communication antenna transceiver 54 performs the RF signalling and protocols through the upstream communication antenna 32 necessary to receive data communications from the downstream reader 16, either directly or through the wireless network 46 (FIG. 3). In one embodiment, the communication antenna transceiver 54 enables the reception of SMS messages through the wireless network 46 (FIG. 3).

It will be appreciated that in some other embodiments, the upstream reader 12 may have only the processor 50 and the time stamp antenna transceiver 52, and that the display driver 56 and communication antenna transceiver 54 may be embodied in a physically separate device or system.

The downstream reader 16 includes a processor 60 and an interrogation antenna transceiver 62. The interrogation antenna transceiver 62 performs the RF signalling and protocols necessary to excite the downstream antenna(e) 18 and interrogate any transponders 22 (FIG. 3) in the downstream coverage zone(s) 42 (FIG. 3). Response signals from the transponders received at the antenna(e) 18 induce an incoming signal that is received by the interrogation antenna transceiver 62. The response signal, and thus the incoming signal, include information stored in memory in the transponder, including the time stamp and location ID inserted at the upstream reader 12 if the transponder 22 passed through the upstream coverage zone 40.

The processor 60 or the interrogation antenna transceiver 62 may perform suitable demodulation and decoding of the incoming signal to extract the transponder information and, in particular, the timestamp and location ID. The processor 62 may filter out information that does not contain the correct location ID or, if monitoring the travel time between various points, it may group or associate the time stamp information according to the location ID.

The downstream reader 16 includes a time travel determination module 66 and a memory 68. The time travel determination module 66 accumulates time information in the memory 68 and makes a determination as to the approximate travel time between the upstream reader 12 and the downstream reader 16. The determination may be based upon an average of the travel times associated with a number of transponders. It may also be a weighted average or a mean value. Upon detecting a transponder 22 and obtaining its time stamp information, the travel time determination module 66 may calculate the travel time for the particular transponder 22. This calculation involves comparing the time stamp with a current time. The current time may be obtained from the processor 60 or another timing source. It will be appreciated that the timing sources in the upstream reader 12 and the downstream reader 16 are to be synchronized when initialized.

When the travel time determination module 66 calculates a travel time 70 (shown individually as 70a, 70b, . . . , 70n) for a particular transponder 22 it stores the travel time 70 in the memory 68. Once it has accumulated a sufficient number of travel times 70, the travel time determination module 66 may determine an approximate or average travel time. The average travel time may be sent to the upstream reader 12 by way of a communication antenna transceiver 64. The communication antenna transceiver 64 performs the necessary RF signalling and protocols to transmit the average travel time to the upstream reader 12 and/or the wireless network 46 (FIG. 3). In one embodiment, the communication antenna transceiver 64 uses SMS messaging to send the average travel time. In other embodiments, the communication antenna transceiver 64 may send travel time information other than the calculated average travel time. For example, the communication antenna transceiver 64 may send a quantitative travel conditions description or a code relating thereto.

It will also be appreciated that, in some embodiments, the communication antenna transceiver 64 may send the travel time information to a location other than the display sign 26 (FIG. 1) or the upstream reader 12. As noted above in connection with FIG. 1, the travel time information may be sent to a central office or computer for storage, analysis, or retransmission.

Reference is now made to FIG. 6, which shows, in flowchart form, an embodiment of a method 200 of obtaining traffic information. As described above, the method 200 involves a roadway having an upstream reader and a downstream reader. The roadway also has a display sign located in the vicinity of the upstream reader for displaying a message regarding the traffic conditions regarding the section of the roadway between the upstream reader and the downstream reader. The method 200 relates to the operations performed by the downstream reader.

The upstream reader includes a coverage zone spanning a portion of the roadway and it instructs one or more vehicle-mounted transponders passing through the coverage zone to store a time stamp and a location ID. It will be appreciated that it is not necessary that every transponder in the roadway be programmed to store a time stamp. Accordingly, the coverage zone need not span the entire roadway, although in some embodiments it may. If the upstream reader and its coverage zone are placed on an open-road section of the roadway, rather than at a gated section (like a toll plaza), then the upstream reader and its coverage zone are configured so as to be able to communicate with transponders travelling at highway speeds.

The downstream reader has a coverage zone that spans a portion of the roadway. Again, it is not necessary that the entire roadway be covered, although in some embodiments it may be entirely covered.

The method 200 begins in step 202 with the detection of a vehicle in the downstream coverage zone. This may involve transmission of a trigger or wake-up signal from the downstream antenna into the coverage zone and the subsequent reception of a response signal at the downstream antenna from a transponder in the zone. In step 204, the downstream reader obtains transponder information from the transponder memory. In some embodiments, the transponder response signal contains a data string having the contents of its memory, including any information stored in its “scratch pad” section of memory. If the transponder was programmed at the upstream reader, then the transponder information includes the time stamp and location ID.

In step 206, the downstream reader determines whether the transponder information indicates that the transponder was programmed with a time stamp at the upstream reader. It may do this on the basis of the location ID. If the location ID does not correspond to the known location ID of the upstream reader, then the transponder does not contain a relevant time stamp. If the transponder was not programmed at the upstream reader, then the method 200 returns to step 202 to await detection of another transponder. Otherwise, the method 200 continues to step 208, wherein the transponder time stamp is compared to the current time to determine a travel time between the upstream reader and the downstream reader.

Once the travel time is determined in step 208 it may be stored in memory in the downstream reader in step 210. In step 212, the downstream reader determines whether to calculate/update the average travel time. This determination may be based upon accumulating a sufficient number of travel times. It may also or alternatively be based upon predetermined periodic updating. For example, the reader may determine an updated travel time every fifteen minutes. Various combinations and/or modifications will be appreciated by those skilled in the art. Howsoever the downstream reader determines whether or not an update is warranted, if it decides not to update, then the method 200 returns to step 202 to await detection of another transponder. If an updated average travel time is required, then in step 214 the average travel time is calculated. In one embodiment, the average travel time is calculated as the average of all travel times stored in the memory. The average may be based only upon travel times received a preceding time period, such as fifteen minutes, to render the information as current as may be required by the circumstances. In other embodiments, a mean travel time may be determined. In yet other embodiments, a weighted average may be used to determine the average travel time, with greater weight being given to more recent travel times and diminishing importance given to older travel times. Other variations will be understood by those skilled in the art.

After calculating the updated average travel time in step 214, the downstream reader determines whether to send the updated travel time to the display sign. This determination may be based, for example, upon whether the updated travel time varies from the previously calculated travel time by more than a threshold amount. If the variation is not deemed to be significant enough, then the update may not be sent and the method 200 may return to step 202. If the variation exceeds the threshold (for example, a variation of more than 5 or 10%), then in step 218 the downstream reader transmits the updated average travel time to the display sign. This may, for example, include sending a digital electronic message, such as an SMS message, an e-mail, an instant message, or other such communication, through a wireless network connection. Various other mechanisms for communicating the updated travel time from the downstream reader to the display sign will be apparent to those skilled in the art.

References herein to calculation or determination of an “average travel time” will be understood to be broader than mere averaging. In some embodiments, the calculation or determination may involve determining a mean value, a weighted average, or other approximations, to arrive at a travel time for the roadway.

It will also be appreciated that any reference herein to sending a “travel time” or “average travel time” or “travel time information” from the downstream reader to the display sign or display processor are broad enough to include sending quantitative measures or approximate travel time and/or sending qualitative assessments of approximate travel time or traffic conditions.

Referring again to FIG. 3, in another embodiment, the system 10 may include a lane position determination component. Appropriate methods and systems for determining the lane position of a transponder are described in U.S. Pat. No. 6,219,613, issued Apr. 17, 2001, and U.S. patent application Ser. No. 11/176,758, filed Jul. 7, 2005, and owned in common herewith, the contents of which are hereby incorporated by reference. Using such a lane-position determination component, the system 10 may track travel times on a lane-by-lane basis. In other words, the travel times determined, stored, and averaged by the downstream reader 16 may be grouped on a lane-by-lane basis, so that an average travel time may be determined for each lane. This aspect may allow the system 10 to recognize lane-specific slowdowns or problems. It may then display content on the display sign 26 that specifically warns of the lane-specific problem. For example, it may be able to deduce a blockage or accident in a particular lane from the lane-based travel time information.

The present invention may be embodied in other specific forms without departing from the spirit or essential characteristics thereof. Certain adaptations and modifications of the invention will be obvious to those skilled in the art. Therefore, the above discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. A method of obtaining traffic information regarding a roadway using a vehicle equipped with a transponder having a memory, the roadway including a downstream reader having a downstream communications zone over a first portion of the roadway and an upstream reader having an upstream communication zone over a second portion of the roadway, the upstream communication zone being separated from the downstream communication zone by a distance of the roadway, the roadway including a display sign, the method comprising the steps of:
sending a time stamp to the transponder for storage in the memory of the transponder while the vehicle traverses the upstream communication zone;
reading said time stamp from the memory of the transponder when the vehicle is in the downstream communication zone; and
determining a travel time from the upstream communication zone to the downstream communication zone based upon said time stamp, and travel time information based upon said travel time.

2. The method claimed in claim 1, wherein said step of determining includes averaging multiple travel times accumulated from multiple transponders.

3. The method claimed in claim 1, wherein said roadway includes a display sign and wherein said method further includes a step of sending said travel time information to said display sign for display.

4. The method claimed in claim 3, wherein the display sign is located proximate the upstream reader, and wherein the display sign displays content in response to said travel time information.

5. The method claimed in claim 3, wherein said travel time information comprises a quantitative measure of travel time, and wherein the display sign displays said quantitative measure.

6. The method claimed in claim 3, wherein said step of sending includes transmitting a digital message via a wireless network.

7. The method claimed in claim 9, wherein said digital message comprises an SMS message.

8. The method claimed in claim 1, wherein said step of determining includes assigning a qualitative assessment of traffic conditions based upon said travel time, and wherein said travel time information comprises said qualitative assessment.

9. The method claimed in claim 1, wherein said step of sending a time stamp includes sending a programming signal to the transponder, wherein the memory of the transponder includes a locked portion and an unlocked portion, and wherein said time stamp is stored in said unlocked portion in response to said programming signal.

10. The method claimed in claim 1, wherein said downstream reader performs said step of determining.

11. The method claimed in claim 1, wherein said step of sending includes sending a location ID for storage in the memory of the transponder, the location ID corresponding to the upstream reader, and wherein said method further includes a step of checking whether said memory of the transponder includes said location ID corresponding to the upstream reader prior to said step of determining.

12. A system for obtaining traffic information regarding a roadway upon which vehicles equipped with transponders travel, the transponders each having a memory, the system comprising:
a downstream reader having a downstream communications zone over a first portion of the roadway; and
an upstream reader having an upstream communication zone over a second portion of the roadway, the upstream communication zone being separated from the downstream communication zone by a distance of the roadway, the upstream reader having a time stamp transceiver for sending a time stamp to the transponder for storage in the memory of the transponder while one of the vehicles traverses the upstream communication zone,
wherein said downstream reader includes
an interrogation transceiver for reading said time stamp from the memory of the transponder when the vehicle is in the downstream communication zone, and
a travel time module for determining a travel time from the upstream communication zone to the downstream communication zone based upon said time stamp, and determining travel time information based upon said travel time.

13. The system claimed in claim 12, wherein said downstream reader includes a memory storing travel times accumulated from multiple transponders, wherein said travel time module averages said stored travel times to produce an average travel time.

14. The system claimed in claim 12, further including a display sign visible from at least a part of the roadway, and wherein said downstream reader includes a communication module for sending said travel time information to said display sign.

15. The system claimed in claim 13, wherein the display sign is located proximate the upstream reader, and wherein the display sign displays content in response to said travel time information.

16. The system claimed in claim 13, wherein said travel time information comprises a quantitative measure of travel time, and wherein the display sign displays said quantitative measure.

17. The system claimed in claim 13, wherein said travel time module selects a qualitative assessment of traffic conditions based upon said travel time, and wherein said travel time information includes said qualitative assessment, and wherein said display sign displays said qualitative assessment on the display sign.

18. The system claimed in claim 13, wherein said communication module sends said travel time information in a digital message via a wireless network.

19. The system claimed in claim 18, wherein said digital message comprises an SMS message.

20. The system claimed in claim 12, wherein the memory of the transponder includes a locked portion and an unlocked portion, and wherein said time stamp is stored in said unlocked portion in response to a programming signal from said time stamp transceiver.

21. The system claimed in claim 12, wherein said time stamp transceiver sends a location ID for storage in the memory of the transponder, the location ID corresponding to said upstream reader, and wherein said travel time module verifies that the memory of the transponder includes said location ID corresponding to the upstream reader.

22. A downstream reader for use in a system for obtaining traffic information regarding a roadway upon which vehicles equipped with transponders travel, the transponders each having a memory, the system including an upstream reader having an upstream communication zone and storing a time stamp in the memory of a transponder while a vehicle traverses the upstream communication zone, the downstream reader comprising:
a downstream antenna having a downstream communication zone over a portion of the roadway;
an interrogation transceiver connected to said downstream antenna for sending an interrogation signal to the transponder and receiving a response signal, wherein the response signal includes said time stamp; and
a travel time module for determining a travel time from the upstream communication zone to the downstream communication zone based upon said time stamp and travel time information based upon said travel time.

23. The downstream reader claimed in claim 21, wherein said downstream reader includes a memory storing travel times accumulated from multiple transponders, wherein said travel time module averages said stored travel times to produce an average travel time, and wherein said travel time information comprises said average travel time.

24. The downstream reader claimed in claim 21, wherein said travel time module selects a qualitative assessment of traffic conditions based upon said travel time, and wherein said travel time information comprises said qualitative assessment.

25. The downstream reader claimed in claim 21, wherein said system further includes a display sign proximate said roadway, and wherein said downstream further including a communication module for sending said travel time information to said display sign.

26. The downstream reader claimed in claim 25, wherein said communication module sends said travel time information in a digital message via a wireless network.

27. The downstream reader claimed in claim 26, wherein said digital message comprises an SMS message.

28. The downstream reader claimed in claim 21, wherein the upstream reader stores a location ID in the memory of the transponder, the location ID corresponding to the upstream reader, and wherein said travel time module verifies that the memory of the transponder includes said location ID corresponding to the upstream reader.
